(19) United States
(12) Patent Application Publication
(10) Pub. No.: US 2026/0292201 A1
(43) Pub. Date: Sep. 24, 2026

(54) A METHOD, AN APPARATUS AND A COMPUTER PROGRAM PRODUCT FOR IMAGE AND VIDEO CODING

(71) Applicant: Nokia Technologies Oy, Espoo (FI)

(72) Inventors: Miska Matias HANNUKSELA, Tampere (FI); Francesco CRICRÌ, Tampere (FI)

(21) Appl. No.: 19/473,372

(22) PCT Filed: Feb. 15, 2024
(86) PCT No.: PCT/EP2024/053861

§ 371 Date: Oct. 7, 2025

(30) Foreign Application Priority Data
Apr. 12, 2023 (FI) 20235413

(51) Int. Cl. H04N 19/154; H04N 19/70

(52) U.S. Cl. CPC H04N 19/154; H04N 19/70

(57) ABSTRACT

The embodiments relate to method for encoding and decoding. The method for decoding comprises receiving a bitstream; decoding coded frames of the bitstream to respective video frames; forming input data to a processor, wherein the input data comprises data relating to two or more video frames; determining that at least one video frame is missing in the input data; and processing the input data by the processor to generate an output taking the missing at least one video frame into account. The processor may be a neural network based processor. The embodiments also relate to technical equipment for implementing the methods.

### TECHNICAL FIELD

The present solution generally relates to image and video coding. In particular, the present solution relates to image and video coding performed by machine learning systems, such as neural networks.

### BACKGROUND

Neural network is widely used example of machine learning. The operation of neural network—as well as other machine learning models—is based on training. A neural network is able to configure itself based on training data, which is input to the system. After training, the neural network makes predictions and/or decisions over the received input according to its configuration.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus for encoding, the apparatus comprising means for receiving an input video comprising one or more video frames; means for encoding some or all of the one or more video frames into a bitstream; means for encoding information on a processor to be used in decoding into a first message format, wherein the information is indicative that the processor receives input data that comprises data relating to two or more video frames and the information is indicative of processing to be performed in decoding when at least one video frame is missing in the input data; and means for encoding information about activating the processor into a second message format.

According to a second aspect, there is provided an apparatus for decoding, the apparatus comprising means for receiving a bitstream; means for decoding coded frames of the bitstream to respective video frames; means for forming input data to a processor, wherein the input data comprises data relating to two or more video frames; means for determining that at least one video frame is missing in the input data; and means for processing the input data by the processor to generate an output taking the missing at least one video frame into account.

According to a third aspect, there is provided a method for encoding, comprising receiving an input video comprising one or more video frames; encoding some or all of the one or more video frames into a bitstream; encoding information on a processor to be used in decoding into a first message format, wherein the information is indicative that the processor receives input data that comprises data relating to two or more video frames and the information is indicative of processing to be performed in decoding when at least one video frame is missing in the input data; and encoding information about activating the processor into a second message format.

According to a fourth aspect, there is provided a method for decoding, comprising receiving a bitstream; decoding coded frames of the bitstream to respective video frames; forming input data to a processor, wherein the input data comprises data relating to two or more video frames; determining that at least one video frame is missing in the input data; and processing the input data by the processor to generate an output taking the missing at least one video frame into account

According to a fifth aspect, there is provided an apparatus comprising at least one processor, memory including computer program code, the memory and the computer program code configured to, with the at least one processor, cause the apparatus to perform at least the following: receive an input video comprising one or more video frames; encode some or all of the one or more video frames into a bitstream; encode information on a processor to be used in decoding into a first message format, wherein the information is indicative that the processor receives input data that comprises data relating to two or more video frames and the information is indicative of processing to be performed in decoding when at least one video frame is missing in the input data; and encode information about activating the processor into a second message format.

According to a sixth aspect, there is provided an apparatus comprising at least one processor, memory including computer program code, the memory and the computer program code configured to, with the at least one processor, cause the apparatus to perform at least the following: receive a bitstream; decoding coded frames of the bitstream to respective video frames; form input data to a processor, wherein the input data comprises data relating to two or more video frames; determine that at least one video frame is missing in the input data; and process the input data by the processor to generate an output taking the missing at least one video frame into account

According to a seventh aspect, there is provided computer program product comprising computer program code configured to, when executed on at least one processor, cause an apparatus or a system to: receive an input video comprising one or more video frames; encode some or all of the one or more video frames into a bitstream; encode information on a processor to be used in decoding into a first message format, wherein the information is indicative that the processor receives input data that comprises data relating to two or more video frames and the information is indicative of processing to be performed in decoding when at least one video frame is missing in the input data; and encode information about activating the processor into a second message format.

According to an eighth aspect, there is provided computer program product comprising computer program code configured to, when executed on at least one processor, cause an apparatus or a system to: receive a bitstream; decoding coded frames of the bitstream to respective video frames; form input data to a processor, wherein the input data comprises data relating to two or more video frames; determine that at least one video frame is missing in the input data; and process the input data by the processor to generate an output taking the missing at least one video frame into account.

According to an embodiment for decoding, information on the processor is decoded from a first message format, wherein the information is indicative of processing to be performed in decoding when at least one of the two or more video frames is missing; and information about activating the processor is decoded from a second message format; and wherein the forming the input data to the processor is performed in accordance with the decoded information from the first message format and the second message format.

According to an embodiment, the second message format comprises information indicative that at least one video frame is missing in the input data.

According to an embodiment, determining that at least one video frame is missing in the input data comprises concluding that the at least one video frame would originate from an absent coded layer video sequence or from a different coded layer video sequence than a coded layer video sequence that comprises the video frame for which the processor is activated according to the second message format.

According to an embodiment, the first message format comprises information on how to determine replacement frames for replacing said at least one missing video frame.

According to an embodiment, the information comprises an indication that the replacement frames are determined based on one or more available pictures.

According to an embodiment, the information comprises an indication how the replacement frames are determined based on the one or more available pictures.

According to an embodiment, the information comprises sample values in the one or more replacement frames.

According to an embodiment, the first message format comprises an indication of a support of variable number of pictures.

According to an embodiment, the first message format comprises an indication of acceptance of auxiliary input data indicating which video frame is missing.

According to an embodiment, the first message format comprises an indication of a gating functionality for one or more input video frames.

According to an embodiment for decoding, means for concluding based on the second message format a number of times that one or more of the means for forming input data to the processor, the means for determining that at least one video frame is missing in the input data, and the means for processing the input data by the processor is to be performed per a single target picture identified by the second message format; and means for performing the one or more of the means for forming input data to the processor, the means for determining that at least one video frame is missing in the input data, and the means for processing the input data by the processor the number of times per the single target picture identified by the second message format.

According to an embodiment for decoding, one or more output pictures that are determined to precede the beginning of the coded layer video sequence in output order or succeed the end of the coded layer video sequence in output order are discarded.

According to an embodiment, the processor is a neural network based processor. to process input data received from a video decoder.

According to an embodiment, the first message format and the second message format are respectively of a first and second supplemental enhancement information (SEI) type.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a neural network;

FIG. 2 shows an example of a video coding for machines;

FIG. 3 shows an example of an NN postfilter with its input and output;

FIG. 4 shows an example of an NN filter that generates an output picture between two pictures of a coded video sequence;

FIG. 5 shows another example of an NN filter that generates an output picture between two pictures of a coded video sequence;

FIG. 6 is a flowchart illustrating a method for encoding according to an embodiment;

FIG. 7 is a flowchart illustrating a method for decoding according to an embodiment; and

FIG. 8 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

In this disclosure, the terms “picture”, “image”, and “frame” may be used interchangeably. Also, the terms “NN”, “filter”, “NN filter”, “postfilter”, “NN postfilter”, “NNPF” may be used interchangeably. In addition, the terms “machine vision”, “machine vision task”, “machine task”, “machine analysis”, “machine analysis task”, “computer vision”, “computer vision task”, “task network” and “task” may be used interchangeably. Also, the terms “machine consumption” and “machine analysis” may be used interchangeably. And finally, the terms “post-filter”, “post-processing filter” and “postprocessing filter” may be used interchangeably.

The present embodiments are targeted to a multi-input neural network, and in particular to a solution to handle missing input pictures in the multi-input neural network. Before discussing the present embodiments in more detailed manner, a short reference to related technology is given.

In the context of machine learning, a neural network (NN) is a computation graph consisting of several layers of computation, i.e., several portions of computation. Each layer consists of one or more units, where each unit performs an elementary computation. A unit is connected to one or more other units, and the connection may have associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

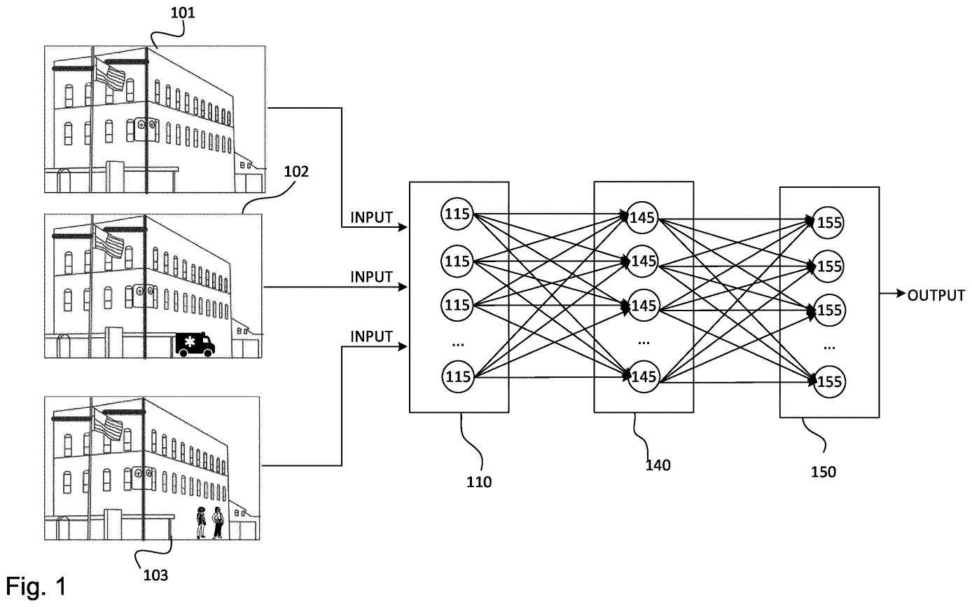

An example of a multi-input NN is illustrated in FIG. 1. The multi-input neural network comprises a sequence of one or more components 110, 140, 150. These components can be called layers. Each component 110, 140, 150 may comprise one or more units 115, 145, 155, i.e., neurons, for performing one or more other operations (such as selection or gating, modulation, etc.). First layer 110, i.e., an input layer, receives multiple inputs, for example multiple images 101, 102, 103. The units 115 of the input layer 110 perform respective operations for the input data and provide outputs for units 145 of the subsequent layer 140. These units 145 perform their operation on the data received from the input layer 110, and provide outputs for units 155 of the subsequent layer 150. There can be a plurality of subsequent layers after the input layer, but for simplicity only two has been illustrated in FIG. 1. Finally, the multi-input neural network comprises an output, which can be a decision or an interpretation performed based on the input data.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

While the above information on neural networks and related training algorithms may be valid at the time when this document was written, the field of neural networks and machine learning in general is developing at a fast pace. Thus, it is to be understood that at least some of the embodiments described herein are not limited to the definition of a neural network, or a machine learning model, or a training algorithm that was given in the background information above.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate). The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC. A reference software for VVC is the VVC Test Model (VTM).

A specification of the AV1 bitstream format and decoding process were developed by the Alliance for Open Media (AOM). The AV1 specification was published in 2018. AOM is reportedly working on the AV2 specification.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams. VUI parameters and SEI messages may, for example, assist in processes related to decoding, display or other purposes.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YcgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

In temporal inter prediction, the sources of prediction are previously decoded pictures in the same scalable layer. In intra block copy (IBC; a.k.a. intra-block-copy prediction), prediction may be applied similarly to temporal inter prediction but the reference picture is the current picture and only previously decoded samples can be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

Image and video codecs may use a set of filters, which may enhance the visual quality of the predicted visual content. Filters may be applied either in-loop or out-of-loop, or both. In-loop filters (which may be also called loop filters) are used in reconstructing prediction reference that may be used for predicting forthcoming video signal. In other words, in the case of in-loop filters, the filter applied on one block in the currently encoded frame may affect the encoding of another block in the same frame and/or in another frame which is predicted from the current frame. An in-loop filter may affect the bitrate and/or the visual quality. In fact, an enhanced block may cause a smaller residual (difference between original block and predicted-and-filtered block), thus requiring less bits to be encoded. An out-of-the loop filter (which may also be called a post-processing filter or a post-filter) may be applied on a frame or part of a frame after it has been reconstructed, the filtered visual content may not be used as a source for prediction, and thus it may only impact the visual quality of the frames that are output by the decoder.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor A to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of the estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sub of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

The phrase along the bitstream (e.g., indicating along the bitstream) or along a coded unit of a bitstream (e.g., indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is included in a container file, such as a file conforming to the ISO Base Media File Format, and certain file metadata is stored in the file in a manner that associates the metadata to the bitstream, such as boxes in the sample entry for a track including the bitstream, a sample group for the track including the bitstream, or a timed metadata track associated with the track including the bitstream. In another example, the phrase along the bitstream may be used when the bitstream is made available as a stream over a communication protocol and a media description, such as a streaming manifest, is provided to describe the stream.

A bitstream may be defined as a sequence of bits, which may in some coding formats or standards be in the form of a network abstraction layer (NAL) unit stream or a byte stream, that forms the representation of coded pictures and associated data forming one or more coded video sequences.

A bitstream format may comprise a sequence of syntax structures. A bitstream format may constrain the order of syntax structures in the bitstream.

A syntax element may be defined as an element of data represented in the bitstream. A syntax structure may be defined as zero or more syntax elements present together in the bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload, when a start code would have occurred otherwise. In order to enable straightforward gateway operation between packet and stream-oriented systems, start code emulation prevention may be performed regardless of whether the bytestream format is in use or not. A NAL unit may be defined as a syntax structure including an indication of the type of data to follow and bytes including that data in the form of a raw byte sequence payload interspersed as necessary with emulation prevention bytes.

A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g., called nuh_layer_id in H.265/HEVC and H.266NVC), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as temporal layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming.

Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266NVC, and H.274NSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Some video coding specifications enable metadata OBUs. A metadata OBU comprises a type field, which specifies the type of metadata.

A coded video sequence (CVS) may be defined as a sequence of coded pictures in decoding order that is independently decodable and is followed by another coded video sequence or the end of the bitstream.

A coded layer video sequence (CLVS) may be defined as a sequence of pictures and associated other data within the same scalable layer (e.g., with the same value of nuh_layer_id in VVC) that is decodable independently of other pictures in the same layer.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance. The variable including a POC value of a picture may be referred to as PicOrderCntVal.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de)coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have idc postfix in its name.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

The neural-network post-filter characteristics (NNPFC) SEI message and the neural-network post-filter activation (NNPFA) SEI message have been described in document JVET-AC2032.

The NNPFC SEI message comprises the nnpfc_id syntax element, which contains an identifying number that may be used to identify a post-processing filter. A base post-processing filter is the filter that is contained in or identified by the first NNPFC SEI message, in decoding order, that has a particular nnpfc_id value within a coded layer video sequence (CLVS). If there is a second NNPFC SEI message that has the same nnpfc_id value that defines the base post-processing filter, an update relative to the base post-processing filter is applied to obtain a post-processing filter associated with the nnpfc_id value. The update may be obtained by decoding the coded neural network bitstream in the second NNPFC SEI message. Otherwise, the post-processing filter associated with the nnpfc_id value is assigned to be the same as the base post-processing filter.

The NNPFC SEI message comprises nnpfc_mode_idc syntax element, the semantics of which may be defined as follows:
nnpfc_mode_idc equal to 1 specifies that the base post-processing filter or the update relative to the base post-processing filter associated with the nnpfc_id value is a neural network identified by the Uniform Resource Identifier (URI) nnpfc_uri with the format identified by the tag URI nnpfc_tag_uri.
nnpfc_mode_idc equal to 0 indicates that this SEI message contains an ISO/IEC 15938-17 bitstream that specifies the base post-processing filter or updates relative to the base post-processing filter with the same nnpfc_id value.

The NNPFC SEI message may also comprise:
Purpose of the post-processing filter, which may comprise, but may not be limited to, one or more of the following:
   Visual quality improvement;
   Chroma upsampling from the 4:2:0 chroma format to the 4:2:2 or 4:4:4 chroma format, or from the 4:2:2 chroma format to the 4:4:4 chroma format;
   Increasing the width or height of the input picture;
   Frame rate upsampling;
   Bit depth upsampling;
   Colourization;
Formatting of the input tensors that are given as input to the neural network inference
Formatting of the output tensors that are resulting from the neural network inference
Characterization of the complexity of the neural network

A frame rate upsampling filter may interchangeably be called a picture rate upsampling filter. Such a filter generates or interpolates one or more pictures between a pair of pictures given as input to the filter. It is also possible to have a frame rate upsampling filter where the number of input pictures may be greater than 2. Such a frame rate upsampling filter may generate pictures between more than one pair of input pictures. A frame rate upsampling filter may comprise a neural network, in which case the generation of the interpolated pictures between a pair of input pictures is performed by the inference of the neural network. It is possible to have a frame rate upsampling filter that extrapolates a picture before input picture(s) or after input picture(s) instead of or in addition to between input pictures.

When the filtering purpose comprises frame rate upsampling, the NNPFC SEI message includes nnpfc_interpolated_pics[i] syntax elements for the value sof i in the range of 0, inclusive, to nnpfc_num_input_pics_minus1, exclusive. nnpfc_num_input_pics_minus1 plus 1 specifies the number of pictures used as input for the NNPF. The variable numinputPics may be set equal to nnpfc_num_input_pics_minus1+1. nnpfc_interpolated_pics[i] specifies the number of interpolated pictures generated by the NNPF between the i-th and the (i+1)-th picture used as input for the NNPF.

The NNPFA SEI message specifies the neural-network post-processing filter (NNPF) that may be used for post-processing filtering for the current picture, or for post-processing filtering for the current picture and one or more other pictures. The NNPFA SEI message comprises the nnpfa_target_id syntax element, which indicates that the neural-network post-processing filter with nnpfc_id equal to nnpfa_target_id may be used for post-processing filtering for the indicated persistence. The indicated persistence may be the current picture only (nnpfa_persistence_flag equal to 0), or until the end of the current CLVS or the next picture, in output order, in the current layer associated with a NNPFA SEI message with the same nnpfa_target_id as the current SEI message (nnpfa_persistence_flag equal to 1).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which contains one or more machines, and runs these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

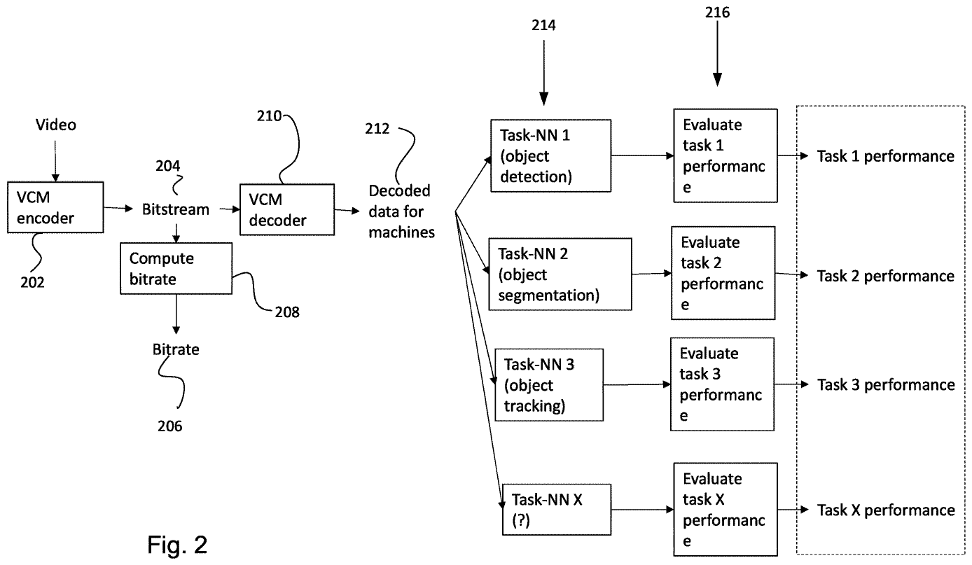

FIG. 2 is a general illustration of the pipeline of Video Coding for Machines. A VCM encoder 202 encodes the input video into a bitstream 204. A bitrate 206 may be computed 208 from the bitstream 204 in order to evaluate the size of the bitstream. A VCM decoder 210 decodes the bitstream output by the VCM encoder 202. In FIG. 2, the output of the VCM decoder 210 is referred to as “Decoded data for machines” 212. This data may be considered as the decoded or reconstructed video. However, in some implementations of this pipeline, this data may not have same or similar characteristics as the original video which was input to the VCM encoder 202. For example, this data may not be easily understandable by a human when rendering the data onto a screen. The output of VCM decoder is then input to one or more task neural networks 214. In the figure, for the sake of illustrating that there may be any number of task-NNs 214, there are three example task-NNs, and a non-specified one (Task-NN X). The goal of VCM is to obtain a low bitrate representation of the input video while guaranteeing that the task-NNs still perform well in terms of the evaluation metric 216 associated to each task.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

When a conventional video encoder, such as a H.266/VVC encoder, is used as a VCM encoder, one or more of the following approaches may be used to adapt the encoding to be suitable to machine analysis tasks:
One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
   The quantization parameter (QP) may be adjusted spatially in a manner that ROIs are encoded using finer quantization step size(s) than other regions. For example, QP may be adjusted CTU-wise.
   The video is preprocessed to contain only the ROIs, while the other areas are replaced by one or more constant values or removed.
   A grid is formed in a manner that a single grid cell covers a ROI. Grid rows or grid columns that contain no ROIs are downsampled as preprocessing to encoding.
Quantization parameter of the highest temporal sublayer(s) is increased (i.e., I coarser quantization is used) when compared to practices for human watchable video.
The original video is temporally downsampled as preprocessing prior to encoding. A frame rate upsampling method may be used as postprocessing subsequent to decoding if machine analysis at the original frame rate is desired.
A filter is used to preprocess the input to the conventional encoder. The filter may be a machine learning based filter, such as a convolutional neural network.

It is beneficial to limit the persistence and/or impact of an SEI message within a CLVS, since such limitation enables concatenating CLVSs originating from different encoded bitstreams next to each other. Likewise, if an SEI message applies across layers, it is beneficial to limit the persistence and/or impact of the SEI message within a CVS, since such limitation enables concatenating CVSs originating from different encoded bitstreams next to each other. Such concatenations may be applied in many use cases, such as including an advertisement video in the middle of a video clip or speaker-driven selection of an input video bitstream in a multi-party video conference to be included into a bitstream to be decoded.

The present embodiments relate to a case where a neural network accepts, as some of its inputs, data relating to two or more video frames. Such data may be two or more video frames decoded by a video decoder, or two or more video frames decoded by a video decoder and filtered by a filter. Also, such data may be two or more patches (blocks) extracted from two or more decoded pictures. For simplicity, a NN accepting two or more video frames is used as an example. There may be cases where one or more frames are not available to be provided as input to the NN, for example at the beginning of a coded layer video sequence (CLVS) or at the end of a CLVS.

Thus, the present embodiments relate to an encoder and to a decoder, wherein the decoder further comprises or is operationally connected to a neural network. In one example, the NN is a post-processing filter (or, for simplicity, NN postfilter or NN filter) that is used by a receiver to post-process pictures that are output by a video decoder. In this example, the purpose of the NN filter is frame-rate upsampling. In another example, the purpose of the NN filter is visual quality improvement. In yet another example, the purpose of the NN filter is chroma upsampling. In the example of frame-rate upsampling, the NN filter takes as input four pictures (that may be associated to positions 0, 2, 4, 6 in relative output order). The NN filter may also receive auxiliary data as input, wherein the auxiliary data may be data derived from the Quantization Parameter (QP) used to code the pictures and/or data derived from the partitioning information generated during coding of the pictures. The NN filter outputs one picture frame that is associated to position 3. In this example it does not matter, how the NN filter arrives at one picture from the four input pictures, i.e., the internal operation of the NN filter does not have to be defined in order to understand the present embodiments. The encoder is configured to signal information about the NN filter to the decoder or the receiver by means of an NNPFC SEI message. The encoder may define any number of post-filters using NNPFC SEI message(s). Furthermore, the encoder may select the pictures for which a particular post-filter is activated. Therefore, the encoder is configured to signal information about activating a certain NN filter for at least some of the pictures to the decoder or the receiver by means of an NNPFA SEI message. The information may comprise an identifying number for the filter, the purpose of the filter, just to mention few as examples.

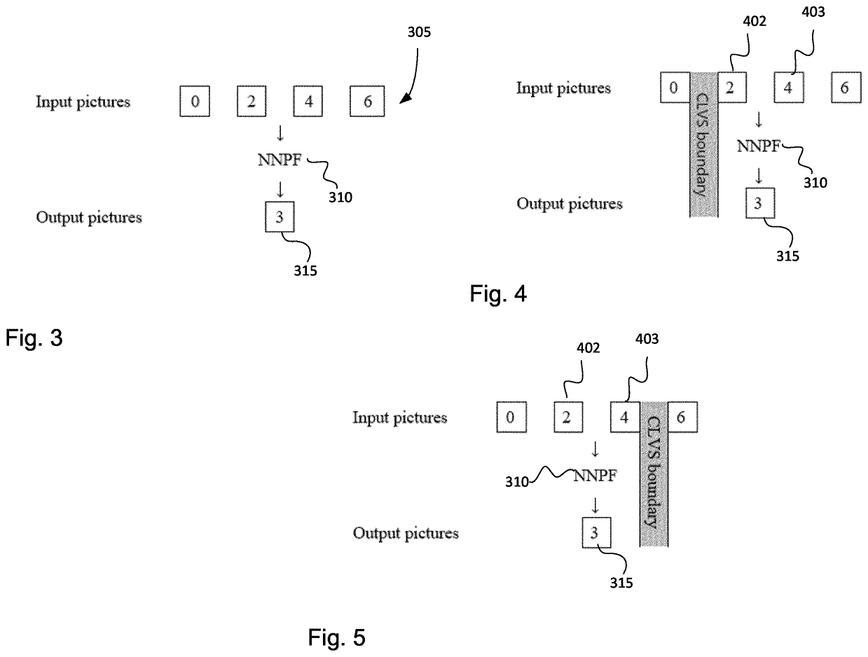

FIG. 3 illustrates the input 305, the NN postfilter (“NNPF”) 310 and the output 315 for this example, where each box in the input 305 represents an input picture, each box in the output 315 represents an output picture, and the numbers within the boxes indicate positions of the input or output pictures in relative output order. The input 305 is formed of decoded video frames, or data relating to them. The input 305 is thus received from a decoder or a filter. The decoder (not shown in the figure) has received the video frames in encoded from an encoder, which also has encoded information on the NNPF 310 to the bitstream, as NNPFC and NNPFA SEI messages. The input 305 comprises video frames. One functionality of the decoder or a post-processor may be to determine whether or not some frames are missing from the input and to generate input data to the NNPF 310 taking into account also the missing frames. One functionality of the NNPF 310 may be to detect missing pictures, as discussed in the embodiments below. For example, the NNPF may obtain, as auxiliary input data, information which input picture are missing. In another example, the NNPF may be trained to identify pictures of a specific constant colour to represent a missing picture.

FIG. 4 illustrates the case where the NN filter 310 is used to generate an output picture 315 between the first two pictures 402, 403 of a CLVS, where these first two pictures 402, 403 are associated to relative positions 2, 4 with respect to the order of the input pictures to the NN filter, and are associated to relative positions 0, 1 with respect to the output order of decoded pictures in a CLVS.

FIG. 5 illustrates the case where the NN filter 310 is used to generate an output picture 315 between the last and second last pictures 402, 403 of a CLVS, where these last and second last pictures 402, 403 are associated to relative positions 2, 4 with respect to the order of the input pictures to the NN filter, and are associated to relative positions N−2, N−1 with respect to the output order of decoded pictures in a CLVS (assuming that the CLVS comprises N pictures and the picture output order indexing starts from 0 and increments by 1 per each decoded picture in output order).

In the following, the present embodiments are discussed with reference to syntax tables. It should be noticed that any byte alignment related syntax may have been ignored for the sake of simplicity. The syntax elements and semantics that have been added to the VSEI specification text JVET-AC2032 or previous examples in this disclosure as result of the present embodiments, have been written in italics to the syntax table.

At least some of the embodiments will be described with reference to or will be complemented with examples of NN post-processing filters. However, it is to be understood that those embodiments and examples may be applicable to other NNs than NN post-processing filters. Furthermore, at least some of the embodiments may be applicable to processes that are not based on neural network technology or machine learning technology, for example to post-processing operations that are not based on neural network technology. The processing needs not to comprise filtering but may comprise any processing, such as a machine analysis task. Furthermore, at least some of the embodiments may be applicable to in-loop filters.

The aim of the present embodiments is to propose ways to handle the case where one or more pictures or data derived from one or more pictures are not available to be input to a neural network (NN). For simplicity, the one or more pictures or data derived from one or more pictures that are not available to be input to a NN are referred to as “one or more missing pictures”.

Concluding which Input Pictures are Missing:

In an embodiment, input pictures that would originate from another CLVS as the current picture for which an NNPF is activated are concluded to be missing.

In an embodiment, input pictures that would originate from another CVS as the current picture for which an NNPF is activated are concluded to be missing.

In an embodiment, input pictures that would originate from another bitstream as the current picture for which an NNPF is activated are concluded to be missing.

In an embodiment, input pictures that would precede, in decoding order, a random access picture (such as a clean random access picture or a gradual decoding refresh picture as defined in H.266/VVC) that is or precedes, in decoding order, the current picture for which an NNPF is activated are concluded to be missing.

In an embodiment, input pictures that would succeed, in decoding order, a random access picture (such as a clean random access picture or a gradual decoding refresh picture as defined in H.266/VVC) that succeeds, in decoding order, the current picture for which an NNPF is activated are concluded to be missing.

In an embodiment, an NNPFA SEI message is signaled for the last picture, in output order, of the input pictures to an NNPF. A decoder selects other input pictures preceding, in output order, said last picture, for example in reverse output order, within a CLVS. If there are no further pictures in reverse output order within a CLVS to be selected as input picture(s), the decoder concludes that input picture(s) are missing.

In an embodiment, an NNPFA SEI message is signaled for the last picture, in output order, of the input pictures to an NNPF and the persistence of the NNPFA SEI message lasts until the end of the CLVS or bitstream. A decoder selects input pictures at the end of the CLVS or bitstream in a manner that at least one of them would originate from beyond the end of the CLVS or bitstream and is hence missing. For example, if there are three input pictures, a decoder may select the first two input pictures in output order to be the last two pictures of the CLVS in output order, and hence the third input picture in output order would originate from beyond the end of the CLVS and is hence missing.

In an embodiment, when an NNPF is active until the end of the CLVS, multiple inferences of the NNPF are performed at the end of the CLVS up to but excluding a set of input pictures that would cause creation of any interpolated picture after the last picture of the CLVS in output order.

In an embodiment, the number of inferences, represented by the variable numInferences, for an NNPF is determined as follows. If all of the following are true:
the filtering purpose comprises frame rate upsampling,
the NNPFA SEI message that activated this NNPF has nnpa_persistence_flag equal to 1 (i.e., persists beyond the current picture),
interpolated pictures are generated by the NNPF between a single pair of input pictures only (i.e., nnpfc_interpolated_pics[i] is greater than 0 only for a single value of i), and
the current picture (which may be denoted with variable currCodedPic) is the last picture in the current CLVS,

the variable numPostRoll is set equal to the value of i such that nnpfc_interpolated_pics[i] is greater than 0 and the variable numInferences is set equal to 1+numPostRoll. Otherwise, the variable numInferences is set equal to 1.

In an embodiment, the picture order count values of input pictures to an NNPF and the presence of the input pictures in a CLVS is determined as follows. It is to be understood that other embodiments may be formed by realizing only specific aspects of this embodiment. The arrays inputPicPoc[i] and inputPicPresentFlag[i] for all values of i in the range of 0 to numinputPics−1, inclusive, specifying the picture order count values of the input pictures for the NNPF and the presence of input pictures within the current CLVS, respectively, are derived as follows:
When j is greater than 0, for each value of k in the range of 0 to j−1, inclusive, inputPicPoc[k] is set equal to PicOrderCntVal of currCodedPic and inputPicPresentFlag[k] is set equal to 0.
inputPicPoc[j] is set equal to PicOrderCntVal of currCodedPic and inputPicPresentFlag[j] is set equal to 1.
When numinputPics is greater than 1, the following applies for each value of i in the range of j+1 to numinputPics−j−1, inclusive, in increasing order of i:
   If currCodedPic is associated with a frame packing arrangement SEI message with fp_arrangement_type equal to 5 and a particular value of fp_current_frame_is_frame0_flag, the following applies:
      If the current CLVS contains a picture prevPic that precedes, in output order, the picture associated with index i−1 and is associated with a frame packing arrangement SEI message with fp_arrangement_type equal to 5 and the same value of fp_current_frame_is_frame0_flag, inputPicPoc[i] is set equal to PicOrderCntVal of prevPic and inputPicPresentFlag[i] is set equal to 1.
      Otherwise, the following applies:
         inputPicPoc[i] is set equal to inputPicPoc[i−1] and inputPicPresentFlag[i] is set equal to 0.
         It is a requirement of bitstream conformance that num_interpolated_pics[i−1] shall not be greater than 0.
   Otherwise (currCodedPic is not associated with a frame packing arrangement SEI message with fp_arrangement_type equal to 5), the following applies:
      If the current CLVS contains a picture prevPic that precedes, in output order, the picture associated with index i−1, inputPicPoc[i] is set equal to PicOrderCntVal of prevPic and inputPicPresentFlag[i] is set equal to 1.
      Otherwise, the following applies:
         inputPicPoc[i] is set equal to inputPicPoc[i−1] and inputPicPresentFlag[i] is set equal to 0.
         It is a requirement of bitstream conformance that num_interpolated_pics[i−1] shall not be greater than 0.

In an embodiment, an NNPFA SEI message is amended to comprise information indicative of missing pictures. An encoder authors an NNPFA SEI message that is indicative of missing pictures. A decoder decodes from an NNPFA SEI message that there are missing pictures.

In an embodiment, an encoder indicates in an NNPFA SEI message and/or a decoder decodes from an NNPFA SEI message the position of the current picture among the input picture list. The input pictures are included in the list in reverse output order. A current picture position greater than 0 indicates that there are missing pictures. The following syntax table is an example of this embodiment:

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| nnpfa_curr_pic_idx | ue(v) |
| } | |
| } | |

nnpfa_curr_pic_idx, according to present embodiments, specifies the index of the current picture among the input pictures. When nnpfa_curr_pic_idx is greater than 0, the input pictures with index in the range of 0 to nnpfa_curr_pic_idx−1, inclusive, are missing. The value of nnpfa_curr_pic_idx is less than the number of input pictures.

The same picture may be associated with multiple NNPFA SEI messages with the same nnpfa_target_id value and different nnpfa_curr_pic_idx values.

In an embodiment, an encoder indicates in an NNPFA SEI message and/or a decoder decodes from an NNPFA SEI message the number of inferences for the activated NNPF. When the number of inferences is greater than 1, the persistence indicated by the NNPFA SEI message (i.e., nnpfa_persistence_flag) may be limited only to the current picture containing the NNPFA SEI message. Alternatively, the syntax elements for indicating the number of inferences may be present only if the persistence is indicated to be the current picture only. It may be further required that the number of inferences is equal to 1 for other pictures than the last picture of the CLVS in output order. The following syntax table is an example of this embodiment:

| | Descriptor |
|---|---|
| nn_post_filter_activation( payloadSize ) { | |
| nnpfa_target_id | ue(v) |
| nnpfa_cancel_flag | u(1) |
| if( !nnpfa_cancel_flag ) { | |
| nnpfa_persistence_flag | u(1) |
| if( nnpfa_persistence_flag = = 0 ) | |
| nnpfa_num_inferences_minus1 | ue(v) |
| } | |
| } | |

nnpfa_num_inferences_minus1 plus 1, according to present embodiments, specifies the number of inferences for a single target picture for which the NNPF is activated by this NNPFA SEI message. When nnpfa_num_inferences_minus1 is not present, it is inferred to be equal to 0. When the NNPFA SEI message is not present in the last picture unit of a CLVS, in output order, nnpfa_num_inferences_minus1 shall be equal to 0.

In an embodiment, a decoder decodes from an NNPFA SEI message the number of inferences for the activated NNPF, denoted numInferences. The decoder executes the inference of the activated NNPF numInferences times. For each of these inferences, the input pictures and/or the indication if they are missing are concluded and indicated to the NNPF, for example according to any other embodiment. For each inference with index i in the range of 0 to numinfrences−1, inclusive, the current picture may, for example, be included as the i-th entry in the list of input pictures and the entries with index less than i may be indicated to be missing. The other input pictures (with index greater than i) may be included in the list of input pictures in reverse output order, i.e., they may precede the current picture in output order.

Signalling Information about Replacement Pictures:

In an embodiment, an encoder signals to a decoder or receiver information about how to replace one or more missing pictures with respective one or more replacement pictures or, in other words, how to determine one or more replacement pictures that replace the one or more missing pictures. This information may be associated to one or more neural networks. For example, this information may be comprised in an NNPFC SEI message.

In an embodiment, the information about how to replace the one or more missing pictures with respective one or more replacement pictures may comprise indicating whether the one or more replacement pictures comprise pixels with same value. In an additional embodiment, the information may comprise indicating the value of pixels in the one or more replacement pictures. In another additional embodiment, the value of pixels in the one or more replacement pictures may be specified in a standard specification.

The following syntax table is an example of these embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) | |
| nnpfc_absent_input_pics_same_value_flag | u(1) |
| ... | |

Where nnpfc_num_input_pics_minus1 plus 1 specifies the number of decoded output pictures used as input for the post-processing filter, nnpfc_absent_input_pics_same_value_flag equal to 1 indicates that missing input pictures shall be replaced with replacement pictures comprising pixels with same value. In this example the value of pixels in replacement pictures is defined in a standard specification, for example the value of pixels in replacement pictures is defined to be zero for all color components.

The following syntax table is another example of these embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) | |
| nnpfc_absent_input_pics_same_value_flag | u(1) |
| if( nnpfc_absent_input_pics_same_value_flag = = | |
| 1 ) { | |
| if( nnpfc_inp_order_idc != 1 ) | |
| nnpfc_absent_input_pics_luma_value | u(v) |
| if( nnpfc_inp_order_idc > 0 ) { | |
| nnpfc_absent_input_pics_cb_value | u(v) |
| nnpfc_absent_input_pics_cr_value | u(v) |
| } | |
| } | |
| ... | |

Where nnpfc_num_input_pics_minus1 plus 1 specifies the number of decoded output pictures used as input for the post-processing filter, nnpfc_absent_input_pics_same_value_flag equal to 1 indicates that missing input pictures shall be replaced with replacement pictures comprising pixels with same value, if(nnpfc_inp_order_idc!=1) is true when the input comprises luma sample array(s) (and false otherwise), nnpfc_absent_input_pics_luma_value specifies the luma sample value of pixels to be used in replacement pictures, if(nnpfc_inp_order_idc>0) is true when the input comprises chroma sample arrays (and false otherwise), and nnpfc_absent_input_pics_cb_value and nnpfc_absent_input_pics_cr_value specify the Cb and Cr sample values, respectively, of pixels to be used in replacement pictures. The length of nnpfc_absent_input_pics_luma_value, when present, is the luma bit depth of input pictures, and the length of nnpfc_absent_input_pics_cb_value and nnpfc_absent_input_pics_cr_value, when present, is the chroma bit depth of input pictures.

In an embodiment, the information about how to replace the one or more missing pictures with respective one or more replacement pictures may comprise indicating whether the one or more replacement pictures are determined based on one or more available pictures. In an additional embodiment, the information may comprise indicating how the one or more replacement pictures are determined based on the one or more available pictures.

The following syntax table is an example of these embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) | |
| nnpfc_absent_input_pics_derived_from_existing_pics_flag | u(1) |
| ... | |

Where nnpfc_num_input_pics_minus1 plus 1 specifies the number of decoded output pictures used as input for the post-processing filter, nnpfc_absent_input_pics_derived_from_existing_pics_flag equal to 1 indicates that missing input pictures shall be replaced with replacement pictures that are derived or determined based at least on pictures that exist in the current CLVS. In this example, a standard specification text may specify that the missing input pictures shall be replaced with replacement pictures that are copies of the closest available picture in the current CLVS, in output order. The picture with relative position 0 is replaced with a copy of picture with relative position 2 (402 in FIG. 4).

The following syntax table is another example of these embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) { | |
| nnpfc_absent_input_pics_derived_from_existing_pics_flag | u(1) |
| if( nnpfc_absent_input_pics_derived_from_existing_pics_flag | |
| = = 1 ) | |
| nnpfc_absent_input_pics_derived_from_existing_pics_idc | ue(v) |
| } | |
| ... | |

Where nnpfcnum_input_pics_minus1 plus 1 specifies the number of decoded output pictures used as input for the post-processing filter, nnpfc_absent_input_pics_derived_from_existingpics_flag equal to 1 indicates that missing input pictures shall be replaced with replacement pictures that are derived or determined based at least on pictures that exist in the current CLVS, nnpfc_absent_input_pics_derived_from_existing_pics_idc specifies how the replacement pictures are derived or determined based at least on existing pictures in the current CLVS. For example, the meaning of different values for nnpfc_absent_input_pics_derived_from_existing_pics_idc may be as in the following table:

| nnpfc_absent_input_{—} | |
|---|---|
| pics_derived_from_{—} | |
| existing_pics_idc | Interpretation |
| 0 | The replacement pictures are copies of the |
| | closest available picture in the current CLVS. |
| 1 | The replacement pictures are copies of the |
| | closest available pictures in reverse order, when |
| | more than one input picture is missing. |
| 2 | The replacement pictures are determined as an |
| | average of the available input pictures used for |
| | the current application of the filter. |

The following syntax table is an example for several of the above embodiments:

| | Descriptor |
|---|---|
| nn_post_filter_characteristics( payloadSize ) { | |
| ... | |
| nnpfc_num_input_pics_minus1 | ue(v) |
| if( nnpf_num_input_pics_minus1 > 0 ) | |
| nnpfc_absent_input_pics_zero_flag | u(1) |
| ... | |

Where nnpfc_num_input_pics_minus1 plus 1 specifies the number of decoded output pictures used as input for the post-processing filter, nnpfc_absent_input_pics_zero_flag equal to 1 indicates that missing input pictures shall be replaced with replacement pictures comprising pixels with zero value, whereas nnpfc_absent_input_pics_zero_flag equal to 0 indicates that missing input pictures shall be replaced with replacement pictures determined as copies of the closest input picture in output order in the current CLVS.

The following syntax table is another example of several of the above embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) { | |
| nnpfc_absent_input_pics_replacement_flag | u(1) |
| if( nnpfc_absent_input_pics_replacement_flag = = | |
| 1 ) | |
| nnpfc_absent_input_pics_replacement_idc | ue(v) |
| } | |
| ... | |

Where nnpfc_num_input_pics_minus1 plus 1 specifies the number of decoded output pictures used as input for the post-processing filter, nnpfc_absent_input_pics_replacement_flag equal to 1 indicates that missing input pictures shall be replaced with replacement pictures that are derived or determined according to what is specified by nnpfc_absent_input_pics_replacement_idc, wherein nnpfc_absent_input_pics_replacement_idc specifies how the replacement pictures shall be determined or derived. For example, the meaning of different values for nnpfc_absent_input_pics_replacement_idc may be as in the following table:

| nnpfc_absent_{—} | |
|---|---|
| input_pics_{—} | |
| replacement_idc | Interpretation |
| 0 | The replacement pictures have pixels with |
| | value equal to zero. |
| 1 | The replacement pictures are copies of the |
| | closest available picture in the current CLVS. |
| 2 | The replacement pictures are copies of the |
| | closest available pictures in reverse order, |
| | when more than one input picture is missing. |
| 3 | The replacement pictures are determined as |
| | an average of the available input pictures used |
| | for the current application of the filter. |

In an embodiment, a decoder concludes if an input picture is missing according to any embodiment above and decodes signaling about replacement pictures as described in any embodiment above. The decoder generates replacement pictures in place of missing input pictures according to the decoded signaling.

In an example embodiment, a decoder decodes signaling comprising nnpfc_absent_input_pics_same_value_flag without additional syntax elements of the replacement sample values and concludes missing pictures into values of the inputPicPresentFlag[i] array as described above. When nnpfc_absent_input_pics_same_value_flag is equal to 1 and inputPicPresentFlag[i] is equal to 0 for a value of i, the luma sample array CroppedYPic[i], for the i-th input picture of the NNPF, is an array of samples equal to a pre-defined value, such as 0, and The chroma sample arrays CroppedCbPic[i] and CroppedCrPic[i], for the i-th input picture of the NNPF, are arrays samples equal to a pre-defined value, such as 0.

### Variable Number of Input Pictures:

In one embodiment, an encoder signals to a decoder or receiver information indicating that one or more neural networks support inputting a variable number of pictures. When one or more input pictures are missing, the list of input pictures to the one or more NNs may comprise only pictures in the current CLVS. This information may be associated to the one or more neural networks. For example, this information may be comprised in an NNPFC SEI message.

The following syntax table is another example of several of the above embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) { | |
| nnpfc_absent_input_pics_handling_flag | u(1) |
| if( nnpfc_absent_input_pics_handling_flag = = 1 ) | |
| nnpfc_absent_input_pics_handling_idc | ue(v) |
| } | |
| ... | |

Where nnpfc_num_input_pics_minus1 plus 1 specifies the number of decoded output pictures used as input for the post-processing filter, nnpfc_absent_input_pics_handling_flag equal to 1 indicates that missing input pictures shall be handled according to what is specified by nnpfc_absent_input_pics_handling_idc, nnpfc_absent_input_pics_handling_idc specifies how the missing input pictures shall be handled. For example, the meaning of different values for nnpfc_absent_input_pics_handling_idc may be as in the following table:

| nnpfc_absent_{—} | |
|---|---|
| input_pics_{—} | |
| handling_idc | Interpretation |
| 0 | The NNPF takes a variable number of input pictures, |
| | thus only pictures in the current CLVS shall be used |
| | as input to the NNPF. |
| 1 | Missing pictures shall be replaced with replacement |
| | pictures that have pixels with value equal to zero. |
| 2 | Missing pictures shall be replaced with replacement |
| | pictures that are copies of the closest available |
| | picture in the current CLVS. |
| 3 | Missing pictures shall be replaced with replacement |
| | pictures that are copies of the closest available |
| | pictures in reverse order, when more than one input |
| | picture is missing. |
| 4 | Missing pictures shall be replaced with replacement |
| | pictures that are determined as an average of the |
| | available input pictures used for the current |
| | application of the filter. |

Signalling Information about Auxiliary Input:

In one embodiment, an encoder signals to a decoder or receiver information indicating whether one or more NNs accept auxiliary input data that indicates which input pictures are missing pictures. This information may be associated to one or more neural networks. For example, this information may be comprised in an NNPFC SEI message.

The following syntax table is an example for several of the above embodiments:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) | |
| nnpfc_aux_data_absent_input_pics_flag | u(1) |
| ... | |

Where nnpfc_num_input_pics_minus1 plus 1 specifies the number of decoded output pictures used as input for the post-processing filter, nnpfc_aux_data_absent_input_pics_flag equal to 1 indicates that the filter accepts auxiliary input data that indicates which input pictures are missing pictures.

In another example, a new value for nnpfc_auxiliary_inp_idc is defined to indicate that the one or more NNs accept auxiliary input data that indicates which input pictures are missing pictures. For example, (nnpfc_auxiliary_inp_idc & 0x02) not equal to 0 may be defined to indicate that the input tensor to the NNPF includes auxiliary input data that indicates which input pictures are missing pictures. It is to be understood that embodiments are not limited to the specific bit or value of nnpfc_auxiliary_inp_idc given as the example, but generally apply to any choice of the bit or value of nnpfc_auxiliary_inp_idc used for the indication.

In one embodiment, the auxiliary input data that indicates which input pictures are missing pictures comprises an array where the number of array elements is equal to the number of input pictures of the NN and the value of each array element indicates if a corresponding input picture is missing. For example, the array may comprise elements that have values 0, indicating a missing picture, or 1 indicating that an input picture is not missing. In other words, this auxiliary input data is provided to the filter as a list of binary values, where each binary value in the list is associated to a respective input picture in output order and specifies whether the associated input picture is missing or not.

In an embodiment, a decoder concludes which input pictures are missing as described in other embodiments and generates the auxiliary input data accordingly.

In an embodiment, a decoder generates replacement pictures for the missing pictures and indicates in the auxiliary input data which method was used to generate replacement pictures. For example, the auxiliary input data may comprise an array where each array element indicates if a corresponding input picture is not missing, or otherwise indicates which method was used to generate a replacement picture for the corresponding input picture that is missing.

In one embodiment, an encoder signals to a decoder or receiver information indicating whether one or more NNs accept auxiliary input data that indicates how many pictures are missing at each side of a list of input pictures, assuming a certain order that may be specified in a standard specification or signaled from encoder to decoder or receiver. The syntax may be similar to the one above.

In one example, this auxiliary input data is provided to the filter as two values, where a first value specifies the number of missing pictures on the left side of a list of input pictures in output order, and a second value specifies the number of missing pictures on the right side of a list of input pictures in output order.

In another example, this auxiliary input data is provided to the filter as two values, where a first value is a binary value and specifies whether the missing pictures are on the left side or the right side of a list of input pictures in output order, and a second value specifies the number of missing pictures.

In yet another example, this auxiliary input data is provided to the filter as an unsigned integer value where each bit position corresponds to an input picture. For example, the least significant bit may correspond to the current picture, and the i-th least significant bit position corresponds to the i-th input picture. A bit equal to 0 may be defined to indicate a missing picture and a bit equal to 1 may be defined to indicate that a picture is not missing.

In an embodiment, when one or more input pictures are not available and the NN accepts auxiliary input data that indicates which input pictures are missing, a decoder or receiver may determine respective one or more replacement pictures in any arbitrary way (for example, by using copies of the closest input picture in the current CLVS or by setting all pixels in the replacement pictures to a value equal to zero) or based on other information signaled from the encoder, for example as described in other embodiments of this invention.

### Gating the Input Pictures:

In one embodiment, an encoder signals to a decoder or receiver information indicating whether one or more NNs comprise a mechanism for gating one or more input pictures. This information may be associated to one or more neural networks. For example, this information may be comprised in an NNPFC SEI message. Gating an input picture may be defined as controlling, based on the gating mechanism, whether and/or how the input picture affects the NN inference.

The following syntax table is an example for this embodiment:

| | Descriptor |
|---|---|
| nn_post_filter_characteristics( payloadSize ) { | |
| ... | |
| nnpfc_num_input_pics_minus1 | ue(v) |
| if( nnpfc_num_input_pics_minus1 > 0 ) | |
| nnpfc_gating_inp_pics_flag | u(1) |
| ... | |

Where nnpfc_num_input_pics_minus1 plus 1 specifies the number of decoded output pictures used as input for the post-processing filter, nnpfc_gating_inp_pics_flag equal to 1 indicates that the filter supports gating of input pictures.

When nnpfc_gating_inp_pics_flag is equal to 1, a receiver may provide a gating signal, such as a list of M binary values where M is the number of input frames accepted by the filter, where the gating signal is used by the filter for gating the contribution of the missing pictures at some stage of the filtering pipeline.

### Handling of Outputs:

In one embodiment, when one or more input pictures are missing in the current CLVS, and one or more output pictures of the NN are associated to respective one or more relative positions which are before the first available input picture (at the beginning of the current CLVS) or are after the last available input picture (at the end of the current CLVS), in output order, the one or more output pictures of the NN may be discarded or anyway not used to derive the final output of the NN or the final output of the process using the NN. When these one or more output pictures of the NN are all the output pictures of the NN, then the NN may not be run at all for the considered input pictures.

In one example, the NN is a postfilter with the purpose of visual enhancement and frame-rate upsampling, accepting four input pictures with relative positions of 0, 2, 4, 6 and outputting five output pictures with relative positions of 0, 2, 3, 4, 6, where the output pictures with relative positions of 0, 2, 4, 6 are enhanced versions of the respective input pictures with relative positions 0, 2, 4, 6, and the output picture with relative position 3 is interpolated for the purpose of frame-rate upsampling. When the filter is applied at the beginning of a CLVS where the input picture associated to relative position 0 is missing, the output picture with relative position 0 should be discarded or not used as the final output of the postfiltering process.

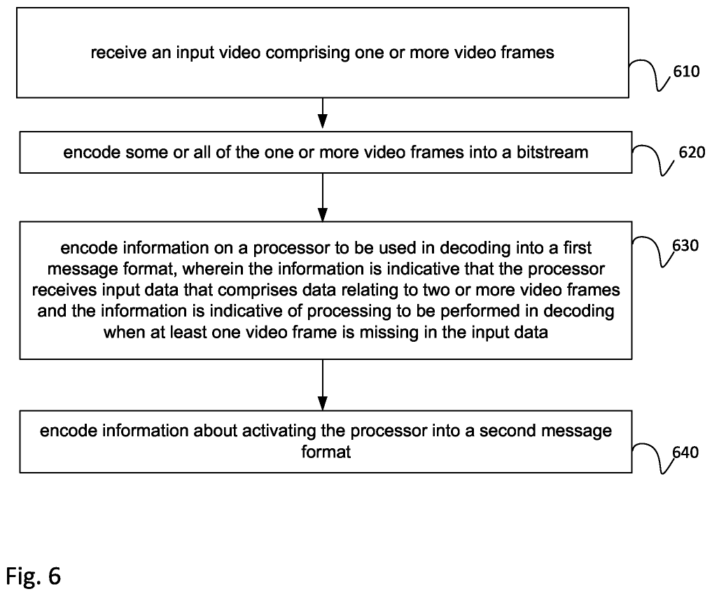

The method for encoding according to an embodiment is shown in FIG. 6. The method generally comprises receiving 610 an input video comprising one or more video frames; encoding 620 some or all of the one or more video frames into a bitstream; encoding 630 information on a processor to be used in decoding into a first message format, wherein the information is indicative that the processor receives input data that comprises data relating to two or more video frames and the information is indicative of processing to be performed in decoding when at least one video frame is missing in the input data; and encoding 640 information about activating the processor into a second message format. Each of the steps can be implemented by a respective module of a computer system

An apparatus for encoding according to an embodiment comprises means for receiving an input video comprising one or more video frames; means for encoding some or all of the one or more video frames into a bitstream; means for encoding information on a processor to be used in decoding into a first message format, wherein the information is indicative that the processor receives input data that comprises data relating to two or more video frames and the information is indicative of processing to be performed in decoding when at least one video frame is missing in the input data; and means for encoding information about activating the processor into a second message format. The means comprises at least one processor, and a memory including a computer program code, wherein the processor may further comprise processor circuitry. The memory and the computer program code are configured to, with the at least one processor, cause the apparatus to perform the method of FIG. 6 according to various embodiments

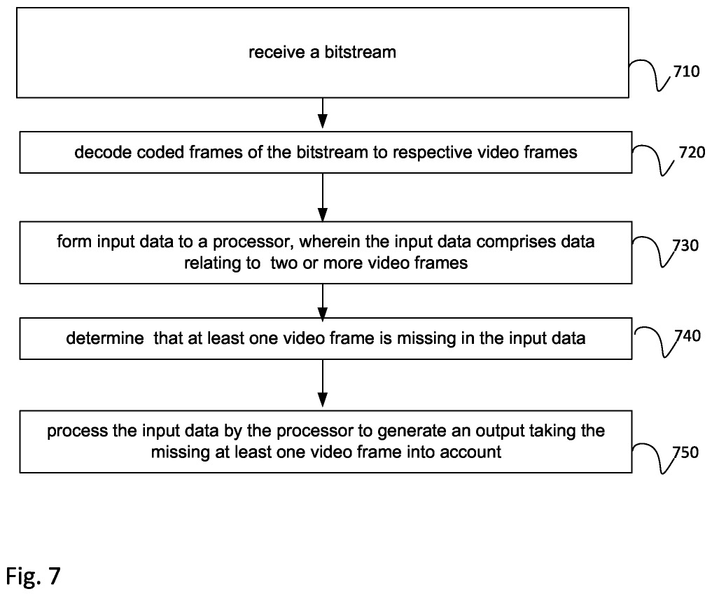

The method for decoding according to an embodiment is shown in FIG. 7. The method generally comprises receiving 710 a bitstream; decoding 720 coded frames of the bitstream to respective video frames; forming 730 input data to a processor, wherein the input data comprises data relating to two or more video frames; determining 740 that at least one video frame is missing in the input data; and processing 750 the input data by the processor to generate an output taking the missing at least one video frame into account. Each of the steps can be implemented by a respective module of a computer system.

An apparatus for decoding according to an embodiment comprises means for receiving a bitstream; means for decoding coded frames of the bitstream to respective video frames; means for forming input data to a processor, wherein the input data comprises data relating to two or more video frames; means for determining that at least one video frame is missing in the input data; and means for processing the input data by the processor to generate an output taking the missing at least one video frame into account. The means comprises at least one processor, and a memory including a computer program code, wherein the processor may further comprise processor circuitry. The memory and the computer program code are configured to, with the at least one processor, cause the apparatus to perform the method of FIG. 7 according to various embodiments.

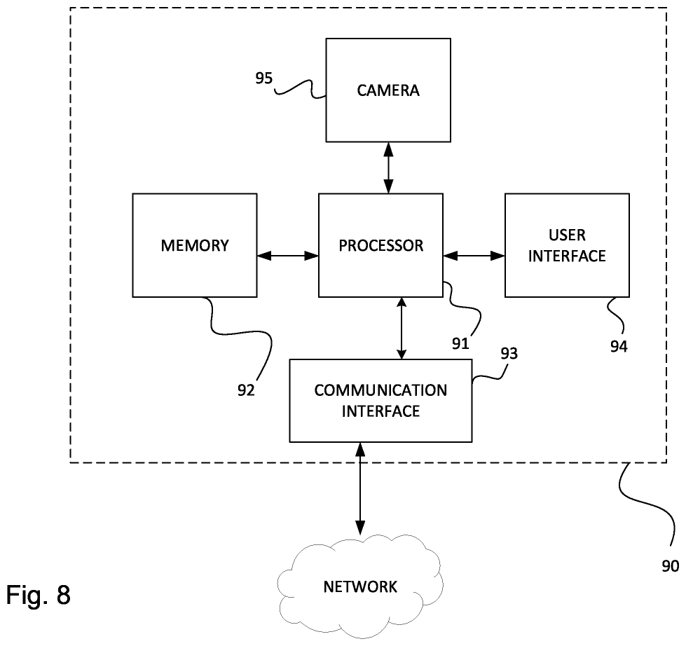

An example of an apparatus is shown in FIG. 8. The apparatus is a user equipment for the purposes of the present embodiments. The apparatus 90 comprises a main processing unit 91, a memory 92, a user interface 94, a communication interface 93. The apparatus according to an embodiment, shown in FIG. 8, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

In the above, where example embodiments have been described with reference to an encoder, it is to be understood that embodiments may be similarly realized with reference to any entity that generates a bitstream or modifies a bitstream by adding syntax structures or syntax elements described in embodiments.

In the above, where example embodiments have been described with reference to a decoder, it is to be understood that embodiments may be similarly realized with reference to any entity that performs decoding or processing as described in embodiments. For example, embodiments may be realized by a post-processor that may be operationally connected to a decoder.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

In the above, some embodiments have been described with reference to specific SEI messages, such as NNPFC SEI message(s) and/or NNPFA SEI message(s). It needs to be understood that embodiments may similarly be realized with any SEI messages of similar nature. For example, some embodiments may be realized with post-filter characteristics and/or activation SEI message(s) where post-filters are not based on neural networks.

In the above, some embodiments have been described with reference to a specific order to determine input pictures to the NNPF, such as a reverse output order. It is to be understood that embodiments may similarly be realized with any pre-defined order, such as a reverse decoding order, a decoding order, or an output order.

In the above, some example embodiments have been described with reference to an SEI message or an SEI NAL unit. It needs to be understood, however, that embodiments may similarly be realized with any similar structures or data units, such as metadata OBUs. Where example embodiments have been described with SEI messages included in a structure, any independently parsable structures could likewise be used in embodiments.

Specific SEI NAL unit and SEI message syntax structures have been presented in example embodiments, but it needs to be understood that embodiments generally apply to any syntax structures with a similar intent as SEI NAL units and/or SEI messages.

In the above, some embodiments have been described with reference to a post-filter or a post-processing filter. It is to be understood that embodiments may similarly be realized with reference to an in-loop filter.

In the above, some embodiments have been described with reference to a filter, post-filter, or alike. It needs to be understood that the embodiments may be realized similarly for any type of processing, such as a machine analysis task.

The various embodiments can be implemented with the help of computer program code that resides in a memory and causes the relevant apparatuses to carry out the method. For example, a device may comprise circuitry and electronics for handling, receiving, and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-19. (canceled)

20. An apparatus comprising: at least one processor, and at least one memory storing instructions that, when executed with the at least one processor, cause the apparatus to perform at least the following: receiving an input video comprising one or more video frames; encoding some or all of the one or more video frames into a bitstream; encoding information on a processor to be used in decoding into a first message format, wherein the information is indicative that the processor receives input data that comprises data relating to two or more video frames and the information is indicative of processing to be performed in decoding when at least one video frame is missing in the input data; and encoding information about activating the processor into a second message format.

21. An apparatus comprising: at least one processor, and at least one memory storing instructions than, when executed with the at least one processor, cause the apparatus to perform at least the following: receiving a bitstream; decoding coded frames of the bitstream to respective video frames; forming input data to a processor, wherein the input data comprises data relating to two or more video frames; determining that at least one video frame is missing in the input data; and processing the input data by the processor to generate an output taking the missing at least one video frame into account.

22. The apparatus of claim 21, wherein the instructions, when executed with the at least one processor, further cause the apparatus to perform: decoding information on the processor from a first message format, wherein the information is indicative of processing to be performed in decoding when at least one of the two or more video frames is missing; and decoding information about activating the processor from a second message format; and wherein the forming the input data to the processor is performed in accordance with the decoded information from the first message format and the second message format.

23. The apparatus of claim 20, wherein the second message format comprises information indicative that at least one video frame is missing in the input data.

24. The apparatus of claim 22, wherein the determining that at least one video frame is missing in the input data comprises concluding that the at least one video frame would originate from an absent coded layer video sequence or from a different coded layer video sequence than a coded layer video sequence that comprises the video frame for which the processor is activated according to the second message format.

25. The apparatus of claim 20, wherein the first message format comprises information on how to determine replacement frames for replacing said at least one missing video frame.

26. The apparatus of claim 25, wherein the information comprises an indication that the replacement frames are determined based on one or more available pictures.

27. The apparatus of claim 25, wherein the information comprises sample values in the one or more replacement frames.

28. The apparatus of claim 20, wherein the first message format comprises an indication of a support of variable number of pictures.

29. The apparatus of claim 20, wherein the first message format comprises an indication of acceptance of auxiliary input data indicating which video frame is missing.

30. The apparatus of claim 20, wherein the first message format comprises an indication of a gating functionality for one or more input video frames.

31. The apparatus of claim 22, wherein the instructions, when executed with the at least one processor, further cause the apparatus to perform: concluding based on the second message format a number of times that one or more of the: forming input data to the processor, determining that at least one video frame is missing in the input data, processing the input data by the processor, is to be performed per a single target picture identified by the second message format; and performing the one or more of the: forming input data to the processor, determining that at least one video frame is missing in the input data, and processing the input data by the processor the number of times per the single target picture identified by the second message format.

32. The apparatus of claim 21, wherein the instructions, when executed with the at least one processor, further cause the apparatus to perform: discarding one or more output pictures that are determined to precede the beginning of the coded layer video sequence in output order or succeed the end of the coded layer video sequence in output order.

33. The apparatus of claim 21, wherein the processor is a neural network based processor to process input data received from a video decoder.

34. The apparatus of claim 20, wherein the first message format and the second message format are respectively of a first and second supplemental enhancement information (SEI) type.

35. A method comprising: receiving a bitstream; decoding coded frames of the bitstream to respective video frames; forming input data to a processor, wherein the input data comprises data relating to two or more video frames; determining that at least one video frame is missing in the input data; and processing the input data by the processor to generate an output taking the missing at least one video frame into account.

36. The method of claim 35, further comprising: decoding information on the processor from a first message format, wherein the information is indicative of processing to be performed in decoding when at least one of the two or more video frames is missing; and decoding information about activating the processor from a second message format; and wherein the forming the input data to the processor is performed in accordance with the decoded information from the first message format and the second message format.

37. The method of claim 36, wherein the determining that at least one video frame is missing in the input data comprises concluding that the at least one video frame would originate from an absent coded layer video sequence or from a different coded layer video sequence than a coded layer video sequence that comprises the video frame for which the processor is activated according to the second message format.

38. The method of claim 35, further comprising: discarding one or more output pictures that are determined to precede the beginning of the coded layer video sequence in output order or succeed the end of the coded layer video sequence in output order.

39. The method of claim 35, wherein the processor is a neural network based processor to process input data received from a video decoder.
